(19) United States
(12) Patent Application Publication
(10) Pub. No.: US 2011/0049159 A1
(43) Pub. Date: Mar. 3, 2011

(54) LID FOR VACUUM-SEALING PACKAGING AND THE MANUFACTURING PROCESS THEREOF

(76) Inventor: Eduardo Jose RENDA, Jaboatao dos Guararapes (BR)

(21) Appl. No.: 12/852,410

(22) Filed: Aug. 6, 2010

Related U.S. Application Data
(63) Continuation of application No. PCT/BR2008/000306, filed on Sep. 19, 2008.

(30) Foreign Application Priority Data
Feb. 12, 2008 (BR) PI 0800319-0

(51) Int. Cl. B65D 51/00; B32B 38/04

(52) U.S. Cl. 220/361; 156/256

(57) ABSTRACT

A lid for vacuum-sealing packaging, which comprises a lid (10) with a film (20) hermetically seated against and retained in the inner surface, said film (20) ensuring the closing of the pass-through hole (11), thus eliminating the need for varnishing the inner surface of the lid and of the release hole.

### CROSS-REFERENCE TO RELATED APPLICATIONS

This Application is a CONTINUATION application claiming the benefit of priority of the co-pending International Patent Application No. PCT/BR2008/000306 with an international filing date of 19 Sep. 2008 that designated the United States, which claims the benefit of priority of Brazil Patent Application No. PI 0800319-0, filed 12 Feb. 2008, the entire disclosures of all Applications are expressly incorporated by reference in their entirety herein.

### INCORPORATION BY REFERENCE

All publications and patent applications mentioned in this specification are herein incorporated by reference to the same extent as if each individual publication or patent application was specifically and individually indicated to be incorporated by reference.

### BACKGROUND OF THE INVENTION

1. Field of the Invention

The present invention refers to a lid for vacuum sealing packaging and the manufacturing process thereof. More specifically, it comprises a lid provided with a release hole covered by a film hermetically seated against and retained in the outer surface of the lid of a vacuum-sealed container.

2. Description of Related Art

Steel packaging originated approximately 200 years ago and became very popular already in the XIX century undergoing an intensive process of improvement over time. Technically, steel packaging is one of the best ways of conditioning foodstuffs and an infinite number of products and has the advantage of avoiding waste and adequately protecting the integrity of its content when transported and marketed. In addition to being resistant, steel packaging is versatile, looks excellent on a supermarket shelf, is totally recyclable, and preserves nutritious properties of foodstuffs better than the manually handled foodstuffs.

Versatility is another quality of steel packaging that may contain from delicate products such as candy and fine cookies to products for industrial use such as lubricating oils and marine boat paints.

The raw material for manufacturing cans is tin-plated or chrome-plated steel. The manufacturing process is completely industrial and is carried out by proper machinery equipment.

Steel cans usually consist of three or more parts: bottom, body of the can, lid and, at last, a ring onto which the lid is affixed.

The body of the cans that consist of three or more pieces is closed by a side seam, which may be electrically welded or joined with a thermoplastic. The components (bottoms, lids or rings) are affixed to the body by bending and tightening in an operation which is called “closing”. Varnish is applied in a process known as varnishing in order to protect the inner surface of a can.

The application of varnishes onto metallic cans is a complete technology. In principle, varnishes are applied when foodstuffs or food ingredients such as sulfur cause a reaction in tinplate or inferior iron forming black sulphides. These black dots are not harmful but change the way a can looks; that is why they must be prevented.

As for the ways of closing packaging, vacuum-sealed metallic packaging may be closed in different ways which are constantly improved, especially, with relation to easy-open lids.

In order to release the vacuum which is formed inside the container, release holes are arranged on the lid. Said release holes are protected by seals as described in the Brazilian Patent BR 9101018, sealing membranes as described in the U.S. Patent 2006249475, or a sealing material as described in the Brazilian Patent BR8400076U which allow a user to easily open a container and ensure the unviolability of the packaging.

The utility model MU7802240 describes a laminar strip applied onto the outer and smooth surface of a flat laminar metallic lid, the lower surface of said laminar strip all being coated with an adhesive substance, setting aside one extremity without said adhesive substance, thus defining a pull tab. The adhesive laminar strip is applied onto a hole provided on the metallic lid, the inner surface of the lid and the hole being coated by a film of protective varnish.

Therefore, the technical literature describes lids for vacuum-sealing metallic packaging that has seals or sealing membranes arranged on the outer surface of said lid thus ensuring the quick opening of the container.

However, it is desirable to arrange a film hermetically seated against and retained in the outer surface of a metallic lid of the vacuum-sealed container so as to close the release hole arranged on the lid and to eliminate the need for varnishing the inner surface of the lid, such lid for vacuum-sealing packaging and the manufacturing process thereof being described and claimed herein.

### BRIEF SUMMARY OF THE INVENTION

In general, the present invention refers to a lid for vacuum-sealing packaging and the manufacturing process thereof.

A lid for vacuum-sealing packaging that eliminates the need for varnishing the inner surface of the lid is a characteristic of the present invention.

### BRIEF DESCRIPTION OF THE DRAWINGS

FIG. 1 shows a sectional view of the lid with the film applied onto the inner surface of said lid.

FIG. 2 shows in detail the arrangement of the film and of the ring for sealing the lid at the mouth of the container.

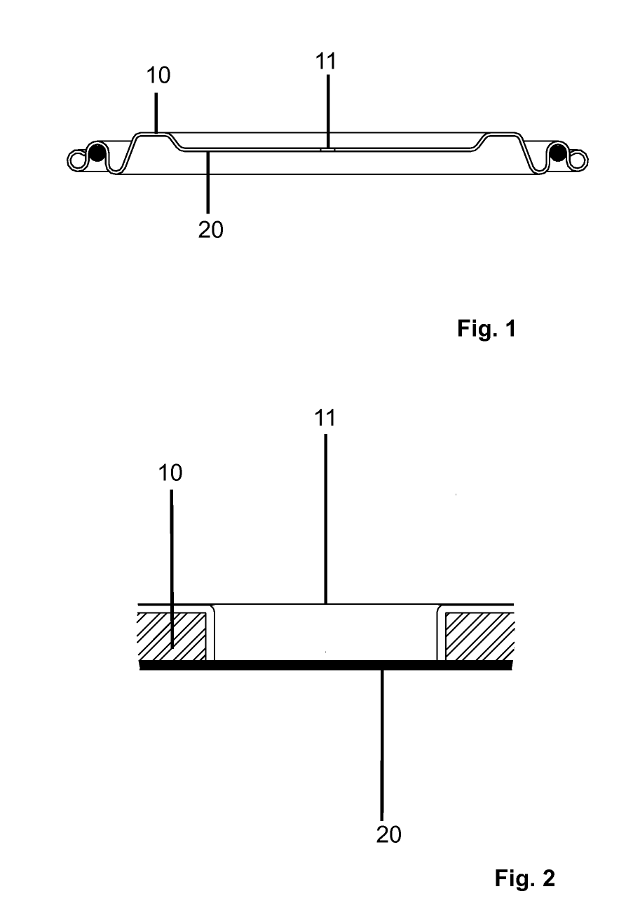

### DETAILED DESCRIPTION OF THE INVENTION

The lid for vacuum-sealing packaging, subject matter of the present invention, comprises a lid (10) seated onto such containers as a can, bottle, or the like, said lid (10) having a pass-through hole (11) to provide the release of the vacuum.

The lid (10) has a film (20) hermetically seated against and retained in the inner surface, said film (20) providing the closing of the pass-through hole (11).

The disposition of the film (20) on the inner surface of the lid (10) eliminates the need for varnishing the inner surface of the lid (10) ensuring quality in the packaging process.

The film (20) may be formed by such materials as plastic, paper, aluminum, or the like, or a combination thereof.

The light-proof material and/or varnish may be applied onto the film (20).

Preferably, the thickness of the film (20) is up to 0.23 μm.

The process of application of the film onto the lid comprises the following stages:

a) pierce the sheet the lid (10) is made of;

b) apply and cure varnish on the outer surface and on the pass-through hole (11) arranged on the sheet the lid (10) is made of;

c) place the film (20) on the inner surface of the sheet the lid (10) is made of;

d) apply the adhesive material, pressure and heat to glue the film (20) onto the inner surface of the sheet the lid (10) is made of;

e) adjust the lid (10).

In order to open the packaging, a piercing object is inserted into the outer region of the pass-through hole (11) arranged on the lid (10), thus piercing the film (20), releasing the vacuum, and opening the container.

What is claimed is:

1. A LID FOR VACUUM-SEALING PACKAGING characterized in that it comprises a lid (10) with a film (20) hermetically seated against and retained in the outer surface, said film (20) ensuring the closing of the pass-through hole (11).

2. A LID FOR VACUUM-SEALING PACKAGING, as set forth in 01, characterized in that the film (20) is formed by plastic, paper, aluminum or the like, or the combination thereof.

3. THE PROCESS OF MANUFACTURING THE LID FOR VACUUM-SEALING PACKAGING AS CLAIMED IN 01 characterized in that it comprises the following stages:
a) pierce the sheet the lid (10) is made of;
b) apply and cure varnish on the outer surface and on the pass-through hole (11) arranged on the sheet the lid (10) is made of;
c) place the film (20) on the inner surface of the sheet the lid (10) is made of;
d) apply the adhesive material, pressure and heat to glue the film (20) onto the inner surface of the sheet the lid (10) is made of;
e) adjust the lid (10).
